(19) United States
(12) Patent Application Publication
(10) Pub. No.: US 2026/0297315 A1
(43) Pub. Date: Oct. 1, 2026

(54) OLEFIN-BASED RUBBER CROSSLINKED PRODUCT AND METHOD FOR PRODUCING THE SAME

(71) Applicant: TOYODA GOSEI CO., LTD., Kiyosu-shi (JP)

(72) Inventors: Risa NAKANO, Aichi (JP); Kiyokazu SODEYAMA, Aichi (JP); Taichi NAKASHIMA, Aichi (JP); Motoshi MATSUURA, Aichi (JP)

(21) Appl. No.: 19/551,789

(22) Filed: Feb. 27, 2026

(30) Foreign Application Priority Data
Mar. 26, 2025 (JP) 2025-051943

(51) Int. Cl. C08L 23/16; C08J 3/24; C08J 11/12; C08J 11/28

(52) U.S. Cl. CPC C08L 23/16; C08J 3/24; C08J 11/12; C08J 11/28; C08J 2323/16; C08J 2423/16; C08L 2203/14; C08L 2205/025; C08L 2207/20; C08L 2312/00

(57) ABSTRACT

A method for producing a crosslinked product of ethylene-α-olefin-non-conjugated diene copolymer rubber, including: adding a recycled material, containing used ethylene-α-olefin-non-conjugated diene copolymer rubber and carbon black, which is subjected to application of shear force and devulcanization treatment, to a virgin material containing uncrosslinked ethylene-α-olefin-non-conjugated diene copolymer rubber, carbon black, and a crosslinking agent; mixing the virgin material and the recycled material to prepare a composition; and crosslinking the composition, and a crosslinked product of ethylene-α-olefin-non-conjugated diene copolymer rubber, having both high stiffness and high resistance to electrolytic corrosion without excessively reducing the amount of carbon black or using expensive carbon black.

### CROSS-REFERENCE TO RELATED APPLICATION

This application is based on and claims priority under 35 USC 119 from Japanese Patent Application No. 2025-051943 filed on Mar. 26, 2025.

### TECHNICAL FIELD

The present invention relates to an olefin-based rubber crosslinked product and a method for producing the same.

### BACKGROUND ART

In order to increase the stiffness of rubber, it is effective to include carbon black. However, since rubber containing carbon black is electrically conductive, in a case where the rubber is used at a portion in contact with metal (for example, vehicle weatherstrip), a local cell is formed when water adheres to the portion, a current flows, and electrolytic corrosion of the metal may occur.

Therefore, for rubber used in such applications, it is common to increase the electrical resistance of the rubber by reducing the carbon black content.

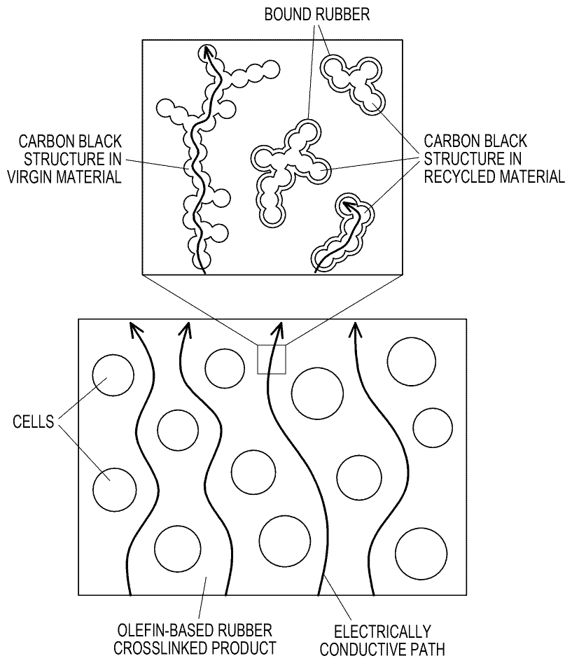

Patent Literature 1 describes an EPDM in which an amount of carbon is reduced to 10 to 23% by mass, and according to FIG. 6 (volume resistivity-carbon content curve), a volume resistivity is 1×10⁷ Ω·cm when the amount of carbon is 23% by mass, and the volume resistivity is 1×10⁶ Ω·cm when the amount of carbon is about 25% by mass.

Patent Literature 2 describes an EPDM containing 10 to 30% by mass of carbon black and having a volume resistivity of 1.0×10⁶ Ω·cm or more.

Patent Literature 3 describes an EPDM containing 19% by mass of carbon black and having a volume resistivity of 7.9×10⁷ Ω·cm (Example 1-1) and an EPDM containing 19% by mass of carbon black and having a volume resistivity of 2.5×10⁶ Ω·cm (Comparative Example 2-1).

Patent Literature 4 describes an EPDM containing 21.9% by mass of carbon black and 27.3% by mass of pulverized bituminous coal, and having a volume resistivity of 2.5×10⁶ Ω·cm (Example 9).

However, reducing the amount of carbon black poses a problem in that the reinforcing effect decreases and the rubber stiffness decreases. It is conceivable to increase the amount of fillers other than carbon black (e.g., white fillers or pulverized bituminous coal as in Patent Literature 4) to compensate for the reduced amount of carbon black; however, this may cause increased die wear, poor kneadability due to a dry/crumbly compound, and foaming due to water absorption by the filler.

In addition, the following examples have been reported in which volume resistivity is increased by selecting/optimizing the carbon black itself while still containing a considerable amount of carbon black.

Patent Literature 5 describes an EPDM containing 34.4% by mass of carbon black specified to have an iodine adsorption amount of 15 to 33 mg/g and a DBP oil absorption amount of 50 to 155 cm³/100 g, and having a volume resistivity of 1.46×10⁶ Ω·cm (Comparative Example 4).

Patent Literature 6 describes an EPDM containing 39.6% by mass of carbon black specified to have an iodine adsorption amount of 10 to 30 mg/g and a DBP oil absorption amount of 110 ml/100 g or more, and having a volume resistivity of 1×10⁶ Ω·cm (Inventive Example 4).

However, the carbon black specified in this manner is expensive.

### CITATION LIST

### Patent Literature

Patent Literature 1: JPH06-210798A
Patent Literature 2: JP2019-34578A
Patent Literature 3: JP2016-175473A
Patent Literature 4: JP2020-139051A
Patent Literature 5: JP2021-105074A
Patent Literature 6: JPH09-317956A

### SUMMARY OF INVENTION

Therefore, an object of the present invention is to provide a crosslinked product of ethylene-α-olefin-non-conjugated diene copolymer rubber (hereinafter referred to as “olefin-based rubber”) having both high stiffness and high resistance to electrolytic corrosion, without excessively reducing the amount of carbon black or using expensive carbon black.

In addition, with the recent growing momentum toward carbon neutrality, reduction of CO₂ emissions is increasingly required even for rubber materials and products that have been mainly based on petroleum-derived materials such as synthetic rubber and carbon black. An object of the present invention is to meet this demand.

As a result of intensive studies, the present inventors have found that a recycled material containing used olefin-based rubber and carbon black, which is subjected to application of shear force and devulcanization treatment, has high electrical resistance, and have further conducted studies, thereby accomplishing the present invention.

[1] A method for producing a crosslinked product of ethylene-α-olefin-non-conjugated diene copolymer rubber, including:
adding a recycled material, containing used ethylene-α-olefin-non-conjugated diene copolymer rubber and carbon black, which is subjected to application of shear force and devulcanization treatment, to a virgin material containing uncrosslinked ethylene-α-olefin-non-conjugated diene copolymer rubber, carbon black, and a crosslinking agent;
mixing the virgin material and the recycled material to prepare a composition; and
crosslinking the composition.

[2] The method for producing the crosslinked product according to [1], in which a difference between a % by mass of the carbon black in the virgin material relative to a total mass of the virgin material and a % by mass of the carbon black in the recycled material relative to a total mass of the recycled material is 10 percentage points or less.

[3] The method for producing the crosslinked product according to [1] or [2], in which an addition ratio of the recycled material relative to a total mass of the composition is 10 to 50% by mass.

[4] The method for producing the crosslinked product according to any of [1] to [3], in which the composition has a minimum Mooney viscosity (Vm) (measured at 125° C. using L-type rotor) of 25 or more.

[5] The method for producing the crosslinked product according to any of [1] to [4], in which the composition contains a foaming agent and foams during crosslinking.

[6] A crosslinked product of ethylene-α-olefin-non-conjugated diene copolymer rubber including crosslinked ethylene-α-olefin-non-conjugated diene copolymer rubber and carbon black,
in which a carbon black content is 35% by mass or more based on a total mass of the crosslinked product,
in which the crosslinked product is a foam having a specific gravity of 0.70 or more, and
in which the crosslinked product has a volume resistivity of 1.5×10⁶ Ω·cm or more.

[7] The crosslinked product according to [6], which may further contain a filler other than carbon black, in which a content of the filler other than carbon black is 20% by mass or less based on the total mass of the crosslinked product.

[8] The crosslinked product according to [6] or [7], which may further contain a white filler, in which a content of the white filler is 10% by mass or less based on the total mass of the crosslinked product.

[9] The crosslinked product according to any of [6] to [8], having a specific gravity of 0.75 or more and a volume resistivity of 1×10⁷ Ω·cm or more.

The crosslinked product according to any of [6] to [8], having a specific gravity of 0.78 or more and a volume resistivity of 1×10⁹ Ω·cm or more.

A rubber member for a vehicle molded from the crosslinked product according to any of [6] to [10].

### <Effects of Method for Producing Olefin-Based Rubber Crosslinked Product>

FIGURE is a schematic diagram of an olefin-based rubber crosslinked product produced by a method according to the present invention in which a recycled material is added to a virgin material, followed by mixing to prepare a composition, and the composition is crosslinked.

The virgin material-derived carbon black has a relatively long structure and less bound rubber around the carbon black. In contrast, the recycled material-derived carbon black has a relatively short structure and more bound rubber around the carbon black. This is considered to be because, during the process in which the recycled material is subjected to application of shear force and devulcanization treatment, the carbon black structure is disrupted by shear and the formation of bound rubber also progresses. By including such recycled material-derived carbon black, the number of breaks in electrically conductive paths formed in the rubber when the olefin-based rubber crosslinked product comes into contact with a metal member increases, thereby increasing the volume resistivity.

When the composition is foamed with a foaming agent, the rubber content decreases due to the formation of cells (bubbles), which also narrows conduction paths, thereby increasing the volume resistivity.

In addition, compared with an olefin-based rubber crosslinked product obtained by crosslinking only virgin material, the olefin-based rubber crosslinked product of the present invention can reduce CO₂ emissions by incorporating recycled material.

### <Effects of Olefin-Based Rubber Crosslinked Product>

An olefin-based rubber crosslinked product having a content of carbon black relative to a total mass of the olefin-based rubber crosslinked product of 35% by mass or more, being a foam having a specific gravity of 0.70 or more, and having a volume resistivity of 1.5×10⁶ Ω·cm or more has a high stiffness, lightweight properties, and a high resistance to electrolytic corrosion.

According to the present invention, it is possible to provide an olefin-based rubber crosslinked product having both high stiffness and high resistance to electrolytic corrosion without excessively reducing an amount of carbon black or using expensive carbon black. This also contributes to reduction in CO₂ emissions.

### BRIEF DESCRIPTION OF DRAWINGS

FIGURE is a schematic diagram of an olefin-based rubber crosslinked product produced by a method according to the present invention.

### DESCRIPTION OF EMBODIMENTS

### (1) Virgin Material

### (1-1) Olefin-Based Rubber (Ethylene-α-Olefin-Non-Conjugated Diene Copolymer Rubber)

Examples of an α-olefin include, but are not particularly limited to, propylene, 1-butene, 1-pentene, 1-hexene, 4-methyl-1-pentene, 1-octene, and 1-decene. Among these, propylene or 1-butene is preferable, and propylene is particularly preferable.

Examples of a non-conjugated diene include, but are not particularly limited to, 1,4-hexadiene, dicyclopentadiene, 5-ethylidene-2-norbornene, and 5-vinyl-2-norbornene.

EPDM is most preferable as the olefin-based rubber.

(1-2) Other Polymers (Other than Olefin-Based Rubber)

The virgin material may contain other polymers. Examples of other polymers include, but are not particularly limited to, natural rubber (NR), nitrile rubber (NBR), styrene-butadiene rubber (SBR), and isoprene rubber (IR).

### (1-3) Carbon Black

Carbon black is not particularly limited, for example, generally known carbon black (commercially available products or the like) can be used, and examples thereof include SRF, GPF, FEF, MAF, HAF, ISAF, SAF, FT, and MT. However, it is preferable not to use special and expensive carbon black as described in Patent Literature 6.

A content of the carbon black relative to a total mass of an olefin-based rubber crosslinked product is preferably 35% by mass or more as described above, and more preferably 37 to 40% by mass.

A difference between a % by mass of the carbon black in the virgin material relative to a total mass of the virgin material and a % by mass of carbon black in the recycled material relative to a total mass of the recycled material (absolute value of difference in numerical value, for example, difference between 25% by mass and 30% by mass is 5 percentage points) is not particularly limited, but is preferably 10 points or less as described above, and more preferably points or less. This is because a content of carbon black in the composition is less likely to vary even when an added amount of the recycled material is changed.

### (1-4) White Filler

Examples of a white filler include, but are not particularly limited to, talc, calcium carbonate, calcium oxide, silicon dioxide, clay, diatomaceous earth, and mica.

The white filler is electrically insulating and has a higher specific gravity than carbon black. Therefore, when weight reduction is required, a content of the white filler relative to the total mass of the olefin-based rubber crosslinked product is preferably 10% by mass or less as described above, and more preferably 8% by mass or less.

(1-5) Other Fillers (Other than Carbon Black and White Filler)

Other fillers may be further contained. Examples of other fillers include, but are not particularly limited to, hollow fillers and pulverized bituminous coal.

Examples of the hollow fillers include, but are not particularly limited to, organic hollow fillers and inorganic hollow fillers.

The pulverized bituminous coal is obtained by pulverizing bituminous coal (B1, B2, and C in the coal classification of JIS M1002), and has extremely low electrical conductivity (substantially insulating properties) and lower specific gravity than carbon black.

A content of the filler other than carbon black relative to the total mass of the olefin-based rubber crosslinked product is preferably 20% by mass or less, and more preferably 10% by mass or less. When the content of the filler is 20% by mass or less, Compression Set (CS) and tensile elongation can be satisfactorily maintained, and when the content of the filler is 10% by mass or less, post-processability in subsequent processes such as kneading (mixing) and extrusion can be satisfactorily maintained.

### (1-6) Crosslinking Agent

Examples of the crosslinking agent include, but are not particularly limited to, sulfur-based, organic peroxide-based, quinoid-based, bismaleimide-based, and resin-based crosslinking agents.

Examples of the sulfur-based crosslinking agents include sulfur, sulfur compounds, maleimides, and organic sulfur-containing compounds. Furthermore, a vulcanization accelerator and a vulcanization accelerator aid may be contained. Examples of the vulcanization accelerator include, but are not particularly limited to, thiuram-based, dithiocarbamate-based, thiazole-based, guanidine-based, morpholine-based, sulfenamide-based, and dithiophosphate-based vulcanization accelerators.

Examples of the organic peroxide-based crosslinking agents include benzoyl peroxide, 1,1-bis(t-butylperoxy)-3,3,5-trimethylcyclohexane, n-butyl-4,4′-bis(t-butylperoxy) valerate, and dicumyl peroxide.

### (1-7) Other Additives

The virgin material may contain other additives. Examples of other additives include oils, fatty acids, processing aids, and antioxidants.

### (2) Recycled Material

### (2-1) Used Olefin-Based Rubber

The used olefin-based rubber is not particularly limited in use time and use situation. Examples of the used olefin-based rubber include crosslinked olefin-based rubber products recovered by being removed from discarded automobiles or the like, and in-process waste materials (process scrap) generated in a manufacturing factory of crosslinked olefin-based rubber products. The olefin-based rubber is the same as in (1-1).

(2-2) Other Polymers (Other than Olefin-Based Rubber)

The recycled material may contain other polymers. The other polymers are the same as in (1-2).

### (2-3) Carbon Black

The carbon black is the same as in (1-3).

(2-4) Other Fillers (Other than Carbon Black)

The recycled material may further contain other fillers. Examples of other fillers include, but are not particularly limited to, white fillers, hollow fillers, and pulverized bituminous coal. The white filler is the same as in (1-4). The hollow filler and the pulverized bituminous coal are the same as in (1-5).

### (2-5) Other Additives

The recycled material may contain other additives. The other additives are the same as in (1-7).

### (2-6) Application of Shear Force

Examples of a method for applying a shear force to the recycled material include, but are not particularly limited to, a method using a mixing roll, or a kneading extruder (twin-screw extruder, single-screw extruder, or the like).

Application of shear force and devulcanization treatment on the recycled material may be carried out separately or simultaneously.

Examples of a method in which the application of shear force and the devulcanization treatment are carried out separately include, but are not particularly limited to, a method in which the recycled material is subjected to shear force application by a mixing roll or the like, and then heated by a heating device.

Examples of a method in which the application of shear force and the devulcanization treatment are simultaneously carried out include a method in which the recycled material is kneaded and extruded using a kneading extruder, and is heated by heat generated by shearing during the shear force application.

### (2-7) Devulcanization Treatment

Examples of the devulcanization treatment of the recycled material include, but are not particularly limited to, shear devulcanization, chemical devulcanization, and a combination thereof.

The shear devulcanization is a method of melting and kneading rubber and physically devulcanizing the rubber in a state where a high shear flow field is formed.

The chemical devulcanization is a method in which a sulfur bond in the rubber structure is chemically cleaved by a devulcanizing agent. Examples of the devulcanizing agent include, but are not particularly limited to, the following.
Disulfide compounds (R—S—S—R), thiol compounds (R—SH), dimethyl sulfoxide (DMSO), and amine compounds (NR₃)
A combination of (i) a radical precursor that generates a radical active species capable of cleaving a sulfur bond, and (ii) a radical initiator that generates radicals to convert the radical precursor into the radical active species (i.e., to drive a radical reaction).
Primary phosphine oxides, secondary phosphine oxides, and analogs thereof (phosphite esters and the like), primary phosphines and secondary phosphines which become oxides when oxidized, and analogs thereof, sulfenic acids, and sulfinic acids

### (3) Mixing of Compositions

Examples of a method for mixing the compositions include, but are not particularly limited to, a method using a sealed-type kneader, a mixing roll, or a kneading extruder (twin-screw extruder, single-screw extruder, or the like).

### (4) Rubber Member for Vehicle

Examples of rubber members for vehicles include, but are not limited to, seal members and hoses. In particular, seal members, hoses, and the like that are used in contact with a metal member are preferable in that high resistance to electrolytic corrosion can be utilized.

Examples of the seal member include a weather strip, a boot, and a packing. Examples of the weather strip include weather strips attached to a door, a luggage compartment, a roof side rail, a sliding roof panel, a window, or the like, and also include a door opening trim, a glass run, and the like.

### EXAMPLES

In accordance with a blending formulation in Table 1, a recycled material containing used olefin-based rubber and carbon black, which was subjected to application of shear force and devulcanization treatment was added to a virgin material containing uncrosslinked olefin-based rubber, carbon black, and a crosslinking agent, followed by mixing to prepare a composition, and the composition was crosslinked to prepare an olefin-based rubber crosslinked product.

TABLE 1

| | | 0% material | | 10% material | | 20% material | | 30% material | | 40% material | | 50% material | |
|---|---|---|---|---|---|---|---|---|---|---|---|---|---|
| | | Amount | Amount | Amount | Amount | Amount | Amount | Amount | Amount | Amount | Amount | Amount | Amount |
| | | (phr) | (g) | (phr) | (g) | (phr) | (g) | (phr) | (g) | (phr) | (g) | (phr) | (g) |
| Virgin | EPDM | 100 | 359 | 100 | 323 | 100 | 287 | 100 | 251 | 100 | 215 | 100 | 179 |
| material | Olefin-based | 12 | 43 | 12 | 39 | 12 | 34 | 12 | 30 | 12 | 26 | 12 | 22 |
| | elastomer | | | | | | | | | | | | |
| | Carbon black | 105 | 376 | 105 | 339 | 105 | 301 | 105 | 264 | 105 | 226 | 105 | 188 |
| | Oil | 40 | 143 | 40 | 129 | 40 | 115 | 40 | 100 | 40 | 86 | 40 | 72 |
| | White filler | 5.7 | 20 | 5.7 | 18 | 5.7 | 16 | 5.7 | 14 | 5.7 | 12 | 5.7 | 10 |
| | Processing aid 1 | 6 | 22 | 6 | 19 | 6 | 17 | 6 | 15 | 6 | 13 | 6 | 11 |
| | Processing aid 2 | 1 | 4 | 1 | 3 | 1 | 3 | 1 | 3 | 1 | 2 | 1 | 2 |
| | Processing aid 3 | 2 | 7 | 2 | 6 | 2 | 6 | 2 | 5 | 2 | 4 | 2 | 4 |
| | Crosslinking | 1 | 4 | 1 | 3 | 1 | 3 | 1 | 3 | 1 | 2 | 1 | 2 |
| | agent/accelerating | | | | | | | | | | | | |
| | agent 1 | | | | | | | | | | | | |
| | Crosslinking | 0.75 | 3 | 0.75 | 2 | 0.75 | 2 | 0.75 | 2 | 0.75 | 2 | 0.75 | 1 |
| | agent/accelerating | | | | | | | | | | | | |
| | agent 2 | | | | | | | | | | | | |
| | Crosslinking | 1.5 | 5 | 1.5 | 5 | 1.5 | 4 | 1.5 | 4 | 1.5 | 3 | 1.5 | 3 |
| | agent/accelerating | | | | | | | | | | | | |
| | agent 3 | | | | | | | | | | | | |
| | Crosslinking | 2 | 7 | 2 | 6 | 2 | 6 | 2 | 5 | 2 | 4 | 2 | 4 |
| | agent/accelerating | | | | | | | | | | | | |
| | agent 4 | | | | | | | | | | | | |
| | Crosslinking | 0.5 | 2 | 0.5 | 2 | 0.5 | 1 | 0.5 | 1 | 0.5 | 1 | 0.5 | 1 |
| | agent/accelerating | | | | | | | | | | | | |
| | agent 5 | | | | | | | | | | | | |
| | Foaming agent | 1.4 | 5 | 1.4 | 5 | 1.4 | 4 | 1.4 | 4 | 1.4 | 3 | 1.4 | 3 |
| Recycled | Polymer such as | 0 | 0 | 14.0 | 45.2 | 31.5 | 90.5 | 54.0 | 136 | 84.0 | 181 | 126.0 | 226 |
| material | EPDM | | | | | | | | | | | | |
| | Carbon black | 0 | 0 | 11.6 | 37.6 | 26.2 | 75.3 | 44.9 | 113 | 69.9 | 150 | 104.9 | 188 |
| | Oil | 0 | 0 | 3.6 | 11.5 | 8.0 | 23.0 | 13.7 | 34 | 21.4 | 46 | 32.1 | 58 |
| | White filler | 0 | 0 | 1.8 | 5.7 | 4.0 | 11.4 | 6.8 | 17 | 10.6 | 23 | 15.9 | 28 |

| | | | | | | | |
|---|---|---|---|---|---|---|---|
| Blending | Virgin material [g] | 1,000 | 900 | 800 | 700 | 600 | 500 |
| material | Recycled material [g] | 0 | 100 | 200 | 300 | 400 | 500 |
| | Total [g] | 1,000 | 1,000 | 1,000 | 1,000 | 1,000 | 1,000 |
| Carbon black content | [mass %] | 37.6 | 37.6 | 37.6 | 37.6 | 37.6 | 37.6 |
| White filler content | [mass %] | 2.0 | 2.4 | 2.8 | 3.1 | 3.5 | 3.9 |
| Processability | Roll | No sticking to the roll | No sticking to the roll | Slightly stuck to the roll | Requiring force for peeling | ← | Caught by the roll |
| | Extrusion | Good | ← | ← | ← | ← | ← |
| Uncrosslinked | Mooney Viscosity | 32.2 | 32.2 | 32.4 | 32.6 | 31.2 | 29.6 |
| physical | Vm [−] | | | | | | |
| properties | | | | | | | |
| (foaming) | | | | | | | |
| | Scorch time t5 | 5.4 | 5.7 | 5.8 | 6.3 | 6.2 | 6.4 |
| | [min] | | | | | | |
| Specific | Specific gravity [−] | 0.679 | 0.699 | 0.726 | 0.756 | 0.788 | 0.828 |
| gravity | | | | | | | |
| (foaming) | | | | | | | |
| CS (solid) | CS (ball) [%] | 36 | 42 | 53 | 62 | 70 | 76 |
| Volume | [Ω · cm] | 1.6E+05 | 3.28E+05 | 1.75E+06 | 4.28E+07 | 1.21E+10 | 5.98E+12 |
| resistivity | | | | | | | |
| (foaming) | | | | | | | |

CS: Compression Set
phr: parts by mass per 100 parts by mass of rubber

### <1> Recycled Material

First, recycled materials (having one composition) shown in Table 1 were prepared as follows.

An in-process waste material of a weather strip was pulverized. The weather strip contains crosslinked EPDM, carbon black, oil, and a white filler.

The pulverized material was fed into a twin-screw extruder, and was kneaded and extruded to apply shear force. At the same time, the material was devulcanized by shear devulcanization to obtain a sheet-shaped recycled material.

Components of the recycled material were analyzed by acetone extraction, chloroform extraction, and the like, and it was found that the polymer containing EPDM was 45.2 g, the carbon black was 37.6 g, the oil was 11.5 g, and the filler was 5.7 g in 100 g of the recycled material. That is, the content of the carbon black in the recycled material relative to the total mass of the recycled material was 37.6% by mass.

### <2> Virgin Material

The virgin materials (having one composition) in Table 1 were mixed by dividing the materials into a masterbatch and a final batch. Details of each contained material in Table 1 were as follows.

### <2-1> Masterbatch

EPDM: As the olefin-based rubber (ethylene-α-olefin-non-conjugated diene copolymer rubber), an EPDM containing 5-ethylidene-2-norbornene (ENB) as a non-conjugated diene component was used. In Examples, a grade was selected from commercially available polymers in accordance with various physical properties particularly required for a weather strip; however, the grade may be appropriately changed depending on the product to be produced using the composition.
Olefin-based elastomer: An ethylene-octene copolymer (EOM), which is olefin-based rubber containing no diene component, was further blended.
Carbon black: “ASAHI #60UGS” manufactured by ASAHI CARBON CO., LTD.
Oil: “Diana Process Oil PS-380” manufactured by JXTG Nippon Oil & Energy Corporation
White filler: “CML #31” (calcium oxide) manufactured by Ohmi Chemical Industry Co., Ltd.
Processing aid 1: “Meta-Z-102” (active zinc oxide) manufactured by Inoue Calcium Corporation
Processing aid 2: “LUNAC S-50V” (stearic acid) manufactured by Kao Corporation
Processing aid 3: “EMASTER 430W” (pentaerythritol fatty acid ester) manufactured by Riken Vitamin Co., Ltd.

### <2-2> Final Batch

Crosslinking agent/accelerating agent 1: “NOCCELER M-200” manufactured by OUCHI SHINKO CHEMICAL INDUSTRIAL CO., LTD.
Crosslinking agent/accelerating agent 2: “VULNOC R” manufactured by OUCHI SHINKO CHEMICAL INDUSTRIAL CO., LTD.
Crosslinking agent/accelerating agent 3: “Perkacit ZDBC” manufactured by Flexsys
Crosslinking agent/accelerating agent 4: fine powder sulfur (325 mesh)
Crosslinking agent/accelerating agent 5: “NOCCELER MSA-G” manufactured by OUCHI SHINKO CHEMICAL INDUSTRIAL CO., LTD.
Foaming agent: “Neothrene EM80NA-150M” manufactured by EIWA CHEMICAL IND. CO., LTD

### <2-3> Mixing

First, the masterbatch materials were mixed using a 1.7 L Banbury mixer manufactured by Kobe Steel, Ltd.

Next, the final batch was added to the masterbatch, followed by kneading on a mixing roll (model number: 3729, roll diameter: 8 inches) manufactured by Kansai Roll Co., Ltd.

The content of the carbon black in the virgin material relative to the total mass of the virgin material was 37.6% by mass, which was the same as the content of the carbon black in the recycled material (difference being 0 percentage points).

### <4> Blending Material

As shown in Table 1, the following five blending materials were blended. That is, the content of the carbon black in the recycled material relative to the total mass of the recycled material was 37.6% by mass.
A blended material containing only 1,000 g of virgin material (hereinafter referred to as “0% material”, in which the recycled material content is 0% by mass.)
A blended material obtained by adding 100 g of recycled material to 900 g of virgin material (hereinafter referred to as “10% material”.)
A blended material obtained by adding 200 g of recycled material to 800 g of virgin material (hereinafter referred to as “20% material”.)
A blended material obtained by adding 300 g of recycled material to 700 g of virgin material (hereinafter referred to as “30% material”.)
A blended material obtained by adding 400 g of recycled material to 600 g of virgin material (hereinafter referred to as “40% material”.)
A blended material obtained by adding 500 g of recycled material to 500 g of virgin material (hereinafter referred to as “50% material”.)

### <5> Kneading on Mixing Roll

The blending materials of <4> were kneaded on a mixing roll manufactured by Kansai Roll Co., Ltd.

The processability is shown in Table 1. The 0% material and the 10% material were kneaded extremely well without sticking to the roll. The 20% material was kneaded well although it slightly stuck to the roll. The 30% material and the 40% material were kneaded, but they slightly stuck to the roll and required some force to peel off. The 50% material was caught by the roll several times and could barely be kneaded.

### <6> Extrusion Molding by Continuous Extrusion Vulcanization Equipment

Each blended material after kneading on the mixing roll was extrusion-molded using a continuous extrusion vulcanization line including: a rubber extruder (model EMR-E30) manufactured by E-M Giken Co., Ltd.; a 1.5 kW microwave vulcanizer (model MCV-1.5EM) manufactured by Micro Denshi Co., Ltd.; and two small UHF-line vulcanization tanks manufactured by SPC Electronics Corporation connected in series. At this time, the blending materials were foamed using a foaming agent.

The processability is shown in Table 1. All the blended materials were satisfactorily kneaded and extruded.

### <7> Uncrosslinked Physical Properties

For each blended material in an uncrosslinked state immediately after extrusion using the continuous extrusion vulcanization equipment, the minimum Mooney viscosity (Vm) and the scorch time (t5) were measured at 125° C. using a Mooney viscometer with an L-type rotor in accordance with JIS K6300-1:2013. Measurement results are shown in Table 1.

### <8> Specific Gravity

The specific gravity of the crosslinked olefin-based rubber crosslinked product (foam) was measured 24 hours after extrusion molding using the continuous extrusion vulcanization equipment. Measurement results are shown in Table 1.

### <9> Compression Set (CS)

A large test piece was molded using a vacuum-equipped test piece molding press (model K06HS-XCMX) manufactured by Fugaku Koki Co., Ltd. (170° C. for 15 min), compressed by 25% in accordance with JIS K6262:2013, and held at 70° C. for 72 hours. After removal and release, the compression set (CS) was measured after 30 minutes. Measurement results are shown in Table 1.

### <10> Volume Resistivity

The volume resistivity of the crosslinked olefin-based rubber product (foam) was measured in accordance with JIS K6271-1:2022 by a double-ring electrode method, using four test specimens (length: 100 mm; thickness: approximately 2 mm), under conditions of 23±2° C. and 50±10% relative humidity with an applied voltage of 1.0 V for 60 seconds, 24 hours after extrusion molding using the continuous extrusion vulcanization equipment. Measurement results are shown in Table 1. The volume resistivity of the recycled material is 5.2×10¹² Ω·cm.

### <11> Consideration

Each of the 10% material, the 20% material, the 30% material, the 40% material, and the 50% material has a higher volume resistivity than the 0% material and thus exhibits improved resistance to electrolytic corrosion. Since the electrolytic corrosion resistance can be adjusted according to the intended application, the range of applications can be broadened. Therefore, these materials are positioned as Examples.

Each of the 20% material, the 30% material, the 40% material, and the 50% material is a foam having a specific gravity of 0.70 or more and a volume resistivity of 1.5×10⁶ Ω·cm or more, and is a preferred Example.

Each of the 30% material and the 40% material is a foam having a specific gravity of 0.75 or more and a volume resistivity of 1×10⁷ Ω·cm or more, and showed no problems in processability. Therefore, these materials are more preferred Examples.

The 40% material is a foam having a specific gravity of 0.78 or more and a volume resistivity of 1× 10⁹ Ω·cm or more, and is suitable for applications requiring particularly high resistance to electrolytic corrosion.

The present invention is not limited to the aforementioned Examples and can be appropriately modified and carried out within a scope that does not deviate from the spirit of the invention.

In the Examples, the recycled material was produced from in-process scrap of a weather strip; however, as a modification, the recycled material may be produced from a vulcanized olefin-based rubber product containing carbon black, which is removed from a discarded automobile and recovered. Examples of such products include vehicle seal components, vehicle hoses, rubber belts, and the like.

What is claimed is:

1. A method for producing a crosslinked product of ethylene-α-olefin-non-conjugated diene copolymer rubber, comprising:
adding a recycled material, containing used ethylene-α-olefin-non-conjugated diene copolymer rubber and carbon black, which is subjected to application of shear force and devulcanization treatment, to a virgin material containing uncrosslinked ethylene-α-olefin-non-conjugated diene copolymer rubber, carbon black, and a crosslinking agent;
mixing the virgin material and the recycled material to prepare a composition; and
crosslinking the composition.

2. The method for producing the crosslinked product according to claim 1, wherein a difference between a % by mass of the carbon black in the virgin material relative to a total mass of the virgin material and a % by mass of the carbon black in the recycled material relative to a total mass of the recycled material is 10 percentage points or less.

3. The method for producing the crosslinked product according to claim 1, wherein an addition ratio of the recycled material relative to a total mass of the composition is 10 to 50% by mass.

4. The method for producing the crosslinked product according to claim 1, wherein the composition has a minimum Mooney viscosity (Vm), measured at 125° C. using L-type rotor, of 25 or more.

5. The method for producing the crosslinked product according to claim 1, wherein the composition contains a foaming agent and foams during crosslinking.

6. A crosslinked product of ethylene-α-olefin-non-conjugated diene copolymer rubber comprising crosslinked ethylene-α-olefin-non-conjugated diene copolymer rubber and carbon black,
wherein a carbon black content is 35% by mass or more based on a total mass of the crosslinked product,
wherein the crosslinked product is a foam having a specific gravity of 0.70 or more, and
wherein the crosslinked product has a volume resistivity of 1.5×10⁶ Ω·cm or more.

7. The crosslinked product according to claim 6, which may further contain a filler other than carbon black,
wherein a content of the filler other than carbon black is 20% by mass or less based on the total mass of the crosslinked product.

8. The crosslinked product according to claim 6, which may further contain a white filler,
wherein a content of the white filler is 10% by mass or less based on the total mass of the crosslinked product.

9. The crosslinked product according to claim 6, having a specific gravity of 0.75 or more and a volume resistivity of 1×10⁷ Ω·cm or more.

10. The crosslinked product according to claim 6, having a specific gravity of 0.78 or more and a volume resistivity of 1×10⁹ Ω·cm or more.

11. A rubber member for a vehicle molded from the crosslinked product according to claim 6.
